(19) United States
(12) Patent Application Publication
(10) Pub. No.: US 2010/0128490 A1
(43) Pub. Date: May 27, 2010

(54) LIGHT GUIDE PLATE STRUCTURE

(76) Inventor: Yun-Heng SHIU, Shulin City (TW)

Correspondence Address: Muncy, Geissler, Olds & Lowe, PLLC, 4000 Legato Road, Suite 310, FAIRFAX, VA, 22033, US

(21) Appl. No.: 12/507,387

(22) Filed: Jul. 22, 2009

(30) Foreign Application Priority Data
Nov. 26, 2008 (TW) 97215337

(51) Int. Cl. F21V 8/00; F21V 7/00

(52) U.S. Cl. 362/341; 362/625

(57) ABSTRACT

A light guide plate structure includes a light guide plate made of a light-transmitting material, and reflecting sections provided on at least one face of the light guide plate by cutting the face to form a plurality of grooves at predetermined positions. By cutting the face of the light guide plate to form the reflecting sections, the light guide plate structure can be more easily manufactured to ensure good flatness without the risk of deformation and accordingly increased good yield. The light guide plate with good flatness can be precisely assembled to a related electronic element and provides uniform brightness when being used.

### CROSS-REFERENCE TO RELATED APPLICATIONS

This non-provisional application claims priority under 35 U.S.C. §119(a) on Patent Application No(s). 097215337 filed in Taiwan, R.O.C. on Aug. 26, 2008, the entire contents of which are hereby incorporated by reference.

### FIELD OF THE INVENTION

The present invention relates to a light guide plate structure, and more particularly to a light guide plate having reflecting sections provided on at least one face thereof by cutting the face to form a plurality of grooves at predetermined positions, so that the produced light guide plate has good flatness without the risk of deformation and provides uniform brightness when being used.

### BACKGROUND OF THE INVENTION

Generally, a conventional light guide plate structure includes a light guide plate 41 and a plurality of reflecting sections 42 provided on the light guide plate 41, as shown in FIG. 1. The reflecting sections 42 are formed on the light guide plate 41 by way of hot pressing or injection molding. Light beams from one or more light emitting units entering the light guide plate 41 via one side thereof are refracted at the reflecting sections 42 to thereby achieve the light guiding effect.

While the reflecting sections 42 provided on the light guide plate 41 refract the light beams to achieve the light guiding effect, the light guide plate 41 tends to deform and warp as shown in FIG. 2. This is because stress concentration occurs at and around the reflecting sections 42 when they are formed on the light guide plate 41 by hot pressing or injection molding. Therefore, the conventional light guide plate 41 can not meet the required flatness. The deformed or warped light guide plate 41 can not be easily and precisely assembled to a related electronic element, and would cause deviation in light refraction to result in non-uniform brightness when being used.

### SUMMARY OF THE INVENTION

It is therefore a primary object of the present invention to provide a light guide plate structure with good flatness that can be precisely assembled to an electronic element to provide uniform brightness.

To achieve the above and other objects, the light guide plate structure according to a preferred embodiment of the present invention includes a light guide plate made of a light-transmitting material, and reflecting sections provided on at least one face of the light guide plate by cutting the face of the light guide plate to form a plurality of grooves at predetermined positions.

By cutting the face of the light guide plate to form the reflecting sections, the light guide plate structure can be more easily manufactured to ensure good flatness without the risk of deformation and accordingly ensures increased good yield thereof. The light guide plate structure with good flatness allows precise assembling of the light guide plate to a related electronic element and provides uniform brightness when being used.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional light guide plate structure;

FIG. 2 is a side view of the conventional light guide plate structure of FIG. 1;

FIG. 3 is a side view of a light guide plate structure according to a first embodiment of the present invention;

FIG. 4 is a side view of the light guide plate structure of FIG. 3 in use;

FIG. 5 is a top view of the light guide plate structure of FIG. 3 in use;

FIG. 6 is a side view of a light guide plate structure according to a second embodiment of the present invention;

FIG. 7 is a side view of the light guide plate structure of FIG. 6 in use;

FIG. 8 is a top view of the light guide plate structure of FIG. 6 in use;

FIG. 9 is a side view of a light guide plate structure according to a third embodiment of the present invention;

FIG. 10 is a side view of the light guide plate structure of FIG. 9 in use;

FIG. 11 is a top view of the light guide plate structure of FIG. 9 in use;

FIG. 12 is a side view of a light guide plate structure according to a fourth embodiment of the present invention;

FIG. 13 is a side view of a light guide plate structure according to a fifth embodiment of the present invention;

FIG. 14 is a side view of a light guide plate structure according to a sixth embodiment of the present invention;

FIG. 15 is a top view of a light guide plate structure according to a seventh embodiment of the present invention in use;

FIG. 16 is a sectional view taken along line A-A of FIG. 15; and

FIG. 17 is a sectional view taken along line B-B of FIG. 15.

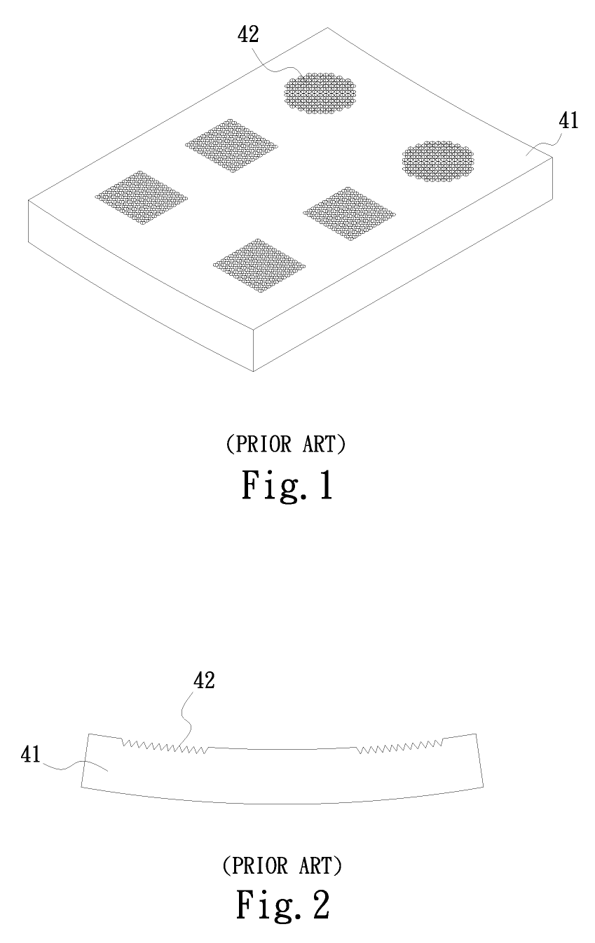

### DETAILED DESCRIPTION OF THE PREFERRED EMBODIMENTS

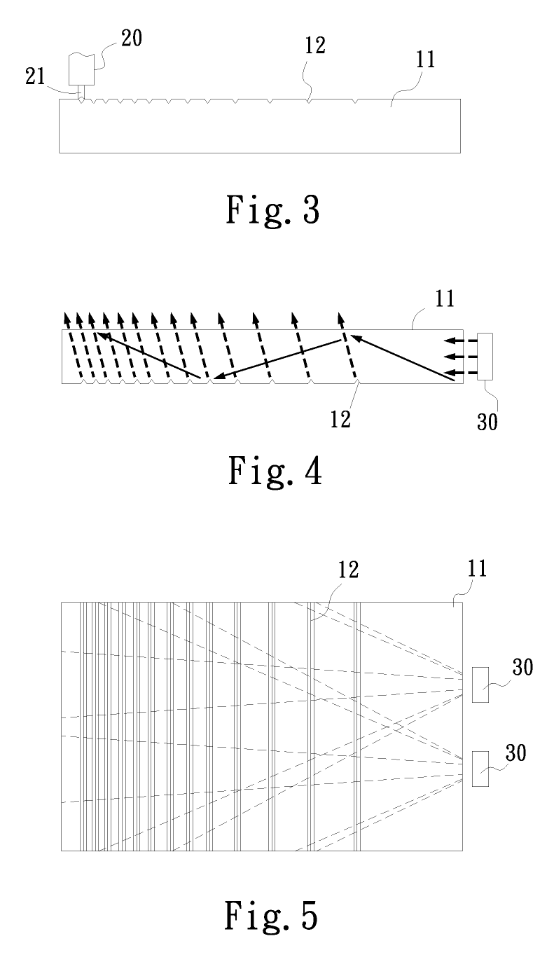

Please refer to FIG. 3 that is a side view of a light guide plate structure according to a first embodiment of the present invention; and to FIGS. 4 and 5 that are side view and top view, respectively, of the light guide plate structure of FIG. 3 in use. As shown, the light guide plate structure according to the first embodiment of the present invention includes a light guide plate 11 and a plurality of reflecting sections 12 provided on the light guide plate 11.

The light guide plate 11 is made of a light transmitting material.

In the illustrated first embodiment, the reflecting sections 12 are provided on one face of the light guide plate 11 by cutting the face with a cutter 21 mounted on a cutting machine 20, so as to form a plurality of V-shaped, U-shaped, or rectangular-shaped grooves at predetermined positions. In the illustrated embodiments of the present invention, the reflecting sections 12 each are a V-shaped groove. In this manner, the light guide plate 11 can be easily manufactured to show good flatness without the risk of deformation. Thus, the light guide plate structure of the present invention can be produced with increased good yield. In the first embodiment, the reflecting sections 12 are formed on one face of the light guide plate 11 at irregular intervals while having the same depth. And, the reflecting sections 12 can longitudinally or transversely extend or form a specific pattern on the face of the light guide plate 11.

The light guide plate structure of the present invention can be associated with related electronic elements to serve as a light guide plate for, for example, keys on different electronic devices, a key board of an electronic produce, a backlight module, an instrument panel, a touch panel, or for a liquid crystal display (LCD). One or more light emitting units 30 as light sources can be correspondingly arranged to at least one side of the light guide plate 11, so that light beams from the light emitting unit 30 enter the light guide plate 11 via the side thereof. The incident light beams are refracted at the reflecting sections 12 and finally exit the light guide plate 11 via another face thereof. With the good flatness thereof, the light guide plate 11 according to the present invention can be precisely assembled to a required electronic element, allowing the incident light beams to be refracted at the reflecting sections 12 to provide uniform brightness. Of course, according to actual need in use, the light emitting units 30 can be separately arranged adjacent to a top, a bottom, a left side, a right side, a front side, a rear side, and/or a central portion of the light guide plate 11, so that the light guide plate structure of the present invention can always meet the requirements in different practical applications.

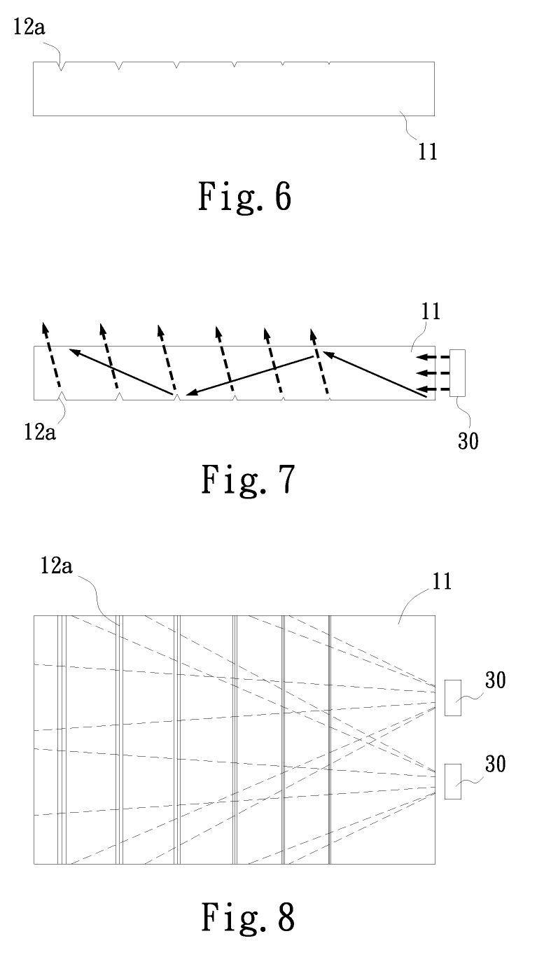

FIG. 6 is a side view of a light guide plate structure according to a second embodiment of the present invention; and FIGS. 7 and 8 are side view and top view, respectively, of the light guide plate structure of FIG. 6 in use. As shown, the light guide plate structure according to the second embodiment of the present invention includes a light guide plate 11 similar to that in the first embodiment, and is provided on one face thereof with a plurality of reflecting sections 12a. The reflecting sections 12a are formed on the face of the light guide plate 11 at regular intervals but have different depths, in order to meet required refracting paths for the light beams from the light sources. Therefore, the light guide plate structure according to the second embodiment of the present invention can also be easily and precisely manufactured without the risk of deformation. Meanwhile, when the light beams from the light emitting units 30 enter the light guide plate 11, a unique refraction effect can be achieved via the reflecting sections 12a, allowing the light guide plate structure of the present invention to always meet the requirements in different practical applications.

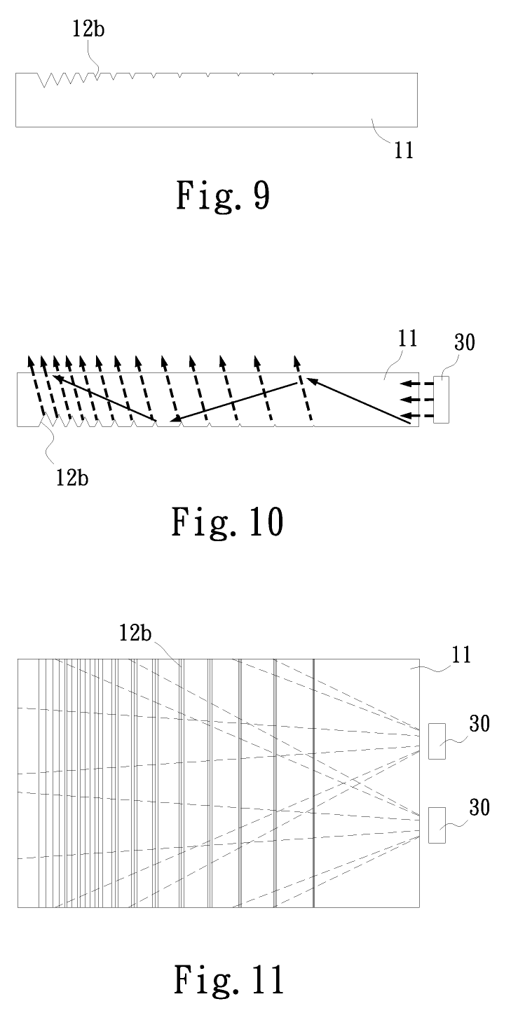

FIG. 9 is a side view of a light guide plate structure according to a third embodiment of the present invention; and FIGS. 10 and 11 are side view and top view, respectively, of the light guide plate structure of FIG. 9 in use. As shown, the light guide plate structure according to the third embodiment of the present invention includes a light guide plate 11 similar to that in the first and the second embodiment, and is provided on one face thereof with a plurality of reflecting sections 12b. The reflecting sections 12b are formed on the face of the light guide plate 11 at irregular intervals and have different depths, in order to meet required refracting paths for the light beams from the light sources. Therefore, the light guide plate structure according to the third embodiment of the present invention can also be easily and precisely manufactured without the risk of deformation. Meanwhile, when the light beams from the light emitting units 30 enter the light guide plate 11, a unique refraction effect can be achieve via the reflecting sections 12b, allowing the light guide plate structure of the present invention to always meet the requirements in different practical applications.

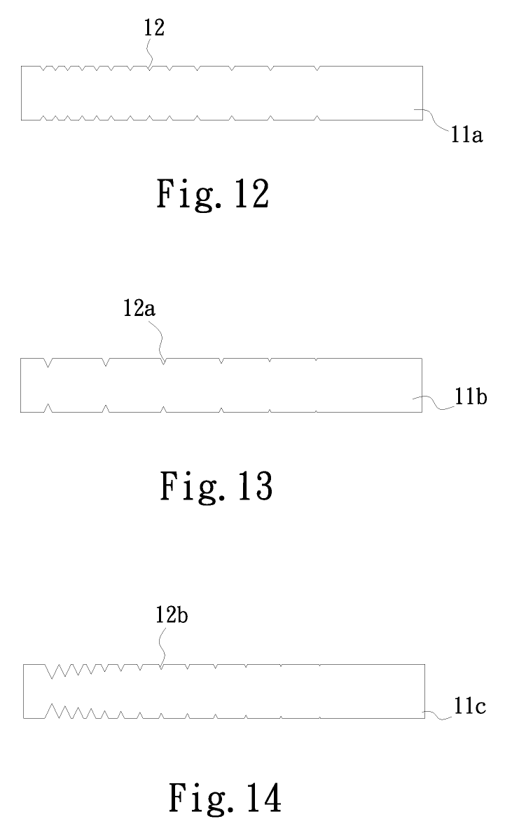

FIGS. 12, 13 and 14 are side views of light guide plate structures according to a fourth, a fifth, and a sixth embodiment of the present invention, respectively. In FIG. 12, the light guide plate structure according to the fourth embodiment of the present invention includes a light guide plate 11a being provided on two opposite faces with a plurality of reflecting sections 12, and the reflecting sections 12 are formed on the faces of the light guide plate 11a at irregular intervals but have the same depth. In FIG. 13, the light guide plate structure according to the fifth embodiment of the present invention includes a light guide plate 11b being provided on two opposite faces with a plurality of reflecting sections 12a, and the reflecting sections 12a are formed on the faces of the light guide plate 11b at regular intervals but have different depths. In FIG. 14, the light guide plate structure according to the sixth embodiment of the present invention includes a light guide plate 11c being provided on two opposite faces with a plurality of reflecting sections 12b, and the reflecting sections 12b are formed on the faces of the light guide plate 11c at irregular intervals and have different depths. The light guide plates 11a, 11b and 11c having differently formed reflecting sections 12, 12b, 12c, respectively, can be used on different electronic products to achieve unique refraction effects, allowing the light guide plate structure of the present invention to always meet the requirements in different practical applications.

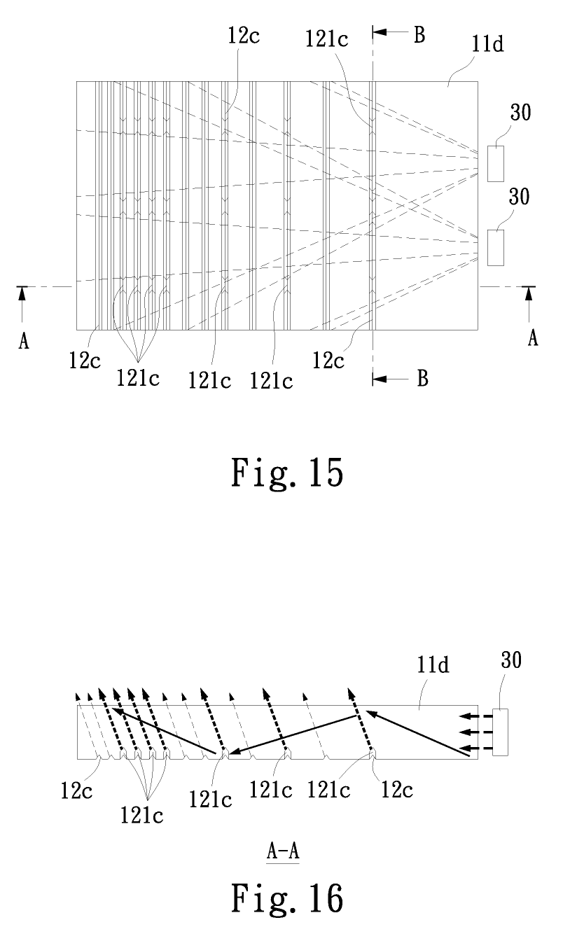

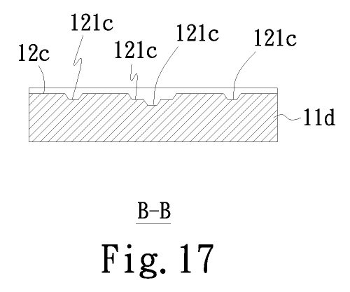

FIG. 15 is a top view of a light guide plate structure according to a seventh embodiment of the present invention in use, and FIGS. 16 and 17 are sectional views taken along lines A-A and B-B of FIG. 15, respectively. As shown, the light guide plate structure according to the seventh embodiment includes a light guide plate 11d, and a plurality of reflecting sections 12c provided on at least one face of the light guide plate 11d. It is noted the reflecting sections 12c are selectively provided therein with at least one sunken area 121c of the same depth or different depths. Light emitting units 30 are arranged to at least one side of the light guide plate 11d, so that light beams emitted from the light emitting units 30 enter the light guide plate 11d and are differently refracted at the reflecting sections 12c and the sunken areas 121c in the reflecting sections 12c, allowing the light guide plate structure of the present invention to show changeful light refracting effects to always meet the requirements in different practical applications.

With the reflecting sections formed on the light guide plate by cutting, the light guide plate structure according to the present invention can be more easily manufactured at increased good yield to have good flatness without being easily subject to deformation. Meanwhile, the manufactured light guide plate can be easily and precisely assembled to a related electronic product and provide uniform brightness when being used. Therefore, the light guide plate structure of the present invention is novel and improved to effectively overcome the drawbacks in the conventional light guide plate structure, and is practical for industrial applications.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A light guide plate structure, comprising:
a light guide plate being made of a light-transmitting material; and
a plurality of reflecting sections being provided on at least one face of the light guide plate by cutting the face to form a plurality of grooves at predetermined positions.

2. The light guide plate structure as claimed in claim 1, wherein the grooves forming the reflecting sections are V-shaped grooves.

3. The light guide plate structure as claimed in claim 1, wherein the grooves forming the reflecting sections are U-shaped grooves.

4. The light guide plate structure as claimed in claim 1, wherein the grooves forming the reflecting sections are rectangular-shaped grooves.

5. The light guide plate structure as claimed in claim 1, wherein the reflecting sections are formed on the at least one face of the light guide plate at regular intervals.

6. The light guide plate structure as claimed in claim 1, wherein the reflecting sections are formed on the at least one face of the light guide plate at irregular intervals.

7. The light guide plate structure as claimed in claim 1, wherein the reflecting sections formed on the at least one face of the light guide plate have the same depth.

8. The light guide plate structure as claimed in claim 1, wherein the reflecting sections formed on the at least one face of the light guide plate have different depths.

9. The light guide plate structure as claimed in claim 1, wherein the reflecting sections are longitudinally formed on the at least one face of the light guide plate.

10. The light guide plate structure as claimed in claim 1, wherein the reflecting sections are transversely formed on the at least one face of the light guide plate.

11. The light guide plate structure as claimed in claim 1, wherein the reflecting sections form a specific pattern on the at least one face of the light guide plate.

12. The light guide plate structure as claimed in claim 1, wherein the reflecting sections are formed on one face of the light guide plate.

13. The light guide plate structure as claimed in claim 1, wherein the reflecting sections are formed on two opposite faces of the light guide plate.

14. The light guide plate structure as claimed in claim 1, wherein the reflecting sections each are provided therein with a plurality of sunken areas having the same depth.

15. The light guide plate structure as claimed in claim 1, wherein the reflecting sections each are provided therein with a plurality of sunken areas having different depths.
